(19) United States
(12) Patent Application Publication
(10) Pub. No.: US 2014/0204103 A1
(43) Pub. Date: Jul. 24, 2014

(54) DATA PROCESSING SYSTEM AND METHOD FOR TASK SCHEDULING IN A DATA PROCESSING SYSTEM

(71) Applicants: Shlomo Beer-gingold, Guivat Shmuel (IL); Eran Weingarten, Gani-Tikva (IL); Michael Zarubinsky, Rishon Lezion (IL)

(72) Inventors: Shlomo Beer-gingold, Guivat Shmuel (IL); Eran Weingarten, Gani-Tikva (IL); Michael Zarubinsky, Rishon Lezion (IL)

(73) Assignee: FREESCALE SEMICONDUCTOR, INC., AUSTIN, TX (US)

(21) Appl. No.: 14/241,926

(22) PCT Filed: Sep. 2, 2011
(86) PCT No.: PCT/IB2011/053857

§ 371 Date: Feb. 28, 2014

(51) Int. Cl. G06T 1/20

(52) U.S. Cl. CPC G06T 1/20
USPC 345/522

(57) ABSTRACT

A data processing system comprises a task scheduling device arranged to schedule a plurality of tasks; and a plurality of processing units, at least some of which being adapted to execute one or more assigned tasks of the plurality of tasks and, for each assigned task, to provide to the task scheduling device at least a task status event which indicates when an execution of the assigned task is finished; wherein the task scheduling device comprises a task scheduler controller unit arranged to assign one or more of the plurality of tasks, each to a corresponding one of the processing units being adapted to execute the assigned task, in response to receiving one or more of the task status events associated with one or more previously assigned tasks.

### FIELD OF THE INVENTION

This invention relates to a data processing system, a method for task scheduling in a data processing system and a computer program product.

### BACKGROUND OF THE INVENTION

Data processing systems or devices for executing modern data processing applications process huge amounts of data using complex processing algorithms. Advanced video processing systems or devices for executing video processing applications, for example, may provide a wide range of processing capabilities, such as, for example, video encoding and decoding, motion compensated frame rate conversion, 3D-video processing etc., in order to provide a high end video experience. In this respect, “processing data” may comprise converting data from one representation into a different one, for example, converting a compressed video data stream into an uncompressed sequence of video frames. It may, for example, also refer to extracting parts of the information contained in the data, such as extracting audio information from multi-media data or detecting objects in video sequences, just to give a few examples.

A data processing system contains one or more processing devices for providing the needed high performance processing power. Data processing systems may, for example, be provided as a system on a chip (SoC) or as circuitry, e.g. located on a printed circuit board (PCB), containing one or more integrated circuit devices. Data processing systems, for example in mobile devices, such as portable computers, smartphones or the like or being part of an automotive apparatus, such as a vehicle etc., may provide limited processing power, requiring efficient usage.

Data processing applications may, for example, be communication network related applications, such as applications for video or multi-media transmission, internet traffic routing, or protocol conversions. Other data processing applications may provide, for example, video content or content combining multiple media data, such as images, video, textual information, audio, or 3D animated graphics. Data processing systems for execution of these applications may, for example, be arranged to process large amounts of data at a processing speed above a minimum processing speed associated with a particular application, such as error-free decoding and uninterrupted display of video sequences received in a compressed data format, just to give an example. The received data may be processed in a pre-determined sequence of consecutive processing stages.

A data processing system may be capable of processing, sequentially or concurrently, data belonging to the same or different applications. For each application, data may be processed at a quality of service (QoS) considered suitable for that particular application. A QoS parameter may, for example, be a required bit rate or image resolution, jitter, delay or bit error rate, just to name a few.

Instead of processing dedicated data on general purpose processors, specialized data processing systems can be used, which, for example, employ hardware acceleration engines, i.e. processing devices optimized for accelerated execution of dedicated tasks. In order to execute the different processing stages for a data set on available processing devices optimized for processing dedicated tasks, multiple-stage processing algorithms and methods are divided into multiple tasks, where each task provides a portion of the total processing needed for a whole data set. A task may correspond to a processing stage or a portion of a processing stage. For example, video processing systems being implemented, for example, on a graphics board or as a SoC, may include hardware acceleration engines arranged to implement, for example, video encoding and decoding, or motion compensated frame rate conversion functionalities and may help to achieve high video quality with reduced hardware complexity and processing latency. Allocating the tasks to dedicated processing devices as efficiently as possible usually contains performing a full search of dependencies between the tasks, in order to enable efficient pipeline processing of tasks depending on each other.

### SUMMARY OF THE INVENTION

The present invention provides a data processing system, a method for task scheduling in a data processing system and a computer program product as described in the accompanying claims.

Specific embodiments of the invention are set forth in the dependent claims.

These and other aspects of the invention will be apparent from and elucidated with reference to the embodiments described hereinafter.

### BRIEF DESCRIPTION OF THE DRAWINGS

Further details, aspects and embodiments of the invention will be described, by way of example only, with reference to the drawings. In the drawings, like reference numbers are used to identify like or functionally similar elements. Elements in the figures are illustrated for simplicity and clarity and have not necessarily been drawn to scale.

FIG. 1 schematically shows a diagram of an example of a first embodiment of a data processing system.

FIG. 2 schematically shows a diagram of an example of a first flow chain.

FIG. 3 schematically shows a diagram of an example of a second embodiment of a data processing system.

FIG. 4 schematically shows a diagram of an example of a third embodiment of a data processing system.

FIG. 5 schematically shows a diagram of an example of a second flow chain.

FIG. 6 schematically shows a diagram illustrating a control flow hierarchy when processing video data.

FIG. 7 schematically shows a diagram of an example of a shared buffer.

FIG. 8 schematically shows a diagram of an example of a third flow chain and associated buffer.

FIG. 9 schematically shows a diagram of an example of a buffer classification logic.

FIG. 10 schematically shows a flow diagram of an example of a behaviour of a task scheduler controller unit.

FIG. 11 schematically shows a diagram of an example of a search for next task to check module of a task scheduler controller unit.

FIG. 12 schematically shows a diagram of an example of an embodiment of a method for task scheduling in a data processing system.

### DETAILED DESCRIPTION OF THE PREFERRED EMBODIMENTS

Because the illustrated embodiments of the present invention may for the most part, be implemented using electronic components and circuits known to those skilled in the art, details will not be explained in any greater extent than that considered necessary, as illustrated, for the understanding and appreciation of the underlying concepts of the present invention and in order not to obfuscate or distract from the teachings of the present invention.

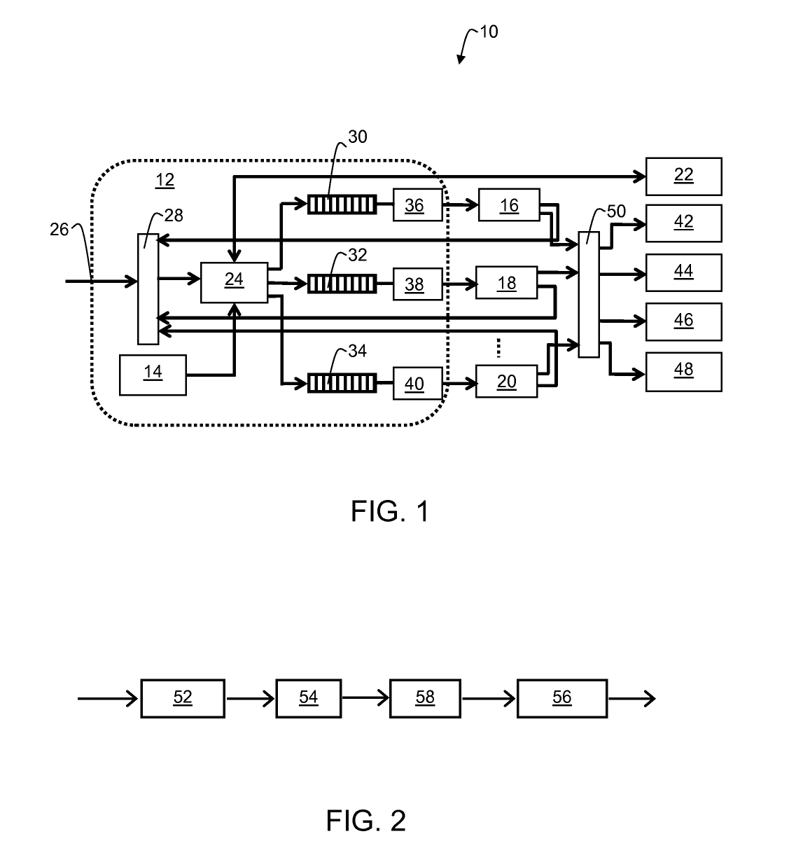

Referring to FIG. 1, a diagram of an example of a first embodiment of a data processing system is schematically shown. The data processing system 10 comprises a task scheduling device 12 arranged to schedule a plurality of tasks; and a plurality of processing units 16, 18, 20, at least some of which being adapted to execute one or more assigned tasks of the plurality of tasks and, for each assigned task, to provide to the task scheduling device 12 at least a task status event which indicates when an execution of the assigned task is finished. The task scheduling device 12 comprises a task scheduler controller unit 24 arranged to assign one or more of the plurality of tasks, each to a corresponding one of the processing units 16, 18, 20 being adapted to execute the assigned task, in response to receiving one or more of the task status events associated with one or more previously assigned tasks.

The data processing system using an event-driven task scheduling approach may provide a fast and resource-saving task search and release and may avoid a conventional full search.

The task scheduling device 12 of the shown data processing system 10 may be arranged to assign tasks to a processing unit 16, 18, 20 and to distribute task assignment between the processing units 16, 18, 20. A task may be a processing algorithm consisting of instructions that can be loaded and executed by a processing unit. A processing unit 16, 18, 20 may be a processing device of the data processing system 10. A processing unit 16, 18, 20 may, for example, be a microprocessor, a microcontroller unit (MCU), a graphics processing unit (GPU) or any other circuitry arranged to execute program instructions of any or dedicated tasks. A processing unit may, for example, be a hardware acceleration engine, i.e. a processing device optimized for accelerated execution of dedicated tasks. Assigning a task to a processing unit may refer to allocating the processing resource, i.e. the processing unit and input and output buffer to the assigned task and the data to be processed.

Scheduling may refer to the way tasks are assigned to run on available processing units. A task scheduling device 12 may be arranged to receive tasks and to decide which task to be assigned when and to which of the processing units 16, 18, 20 in order to increase usage of the processing units 16, 18, 20 and improve performance of the data processing system 10. Performance of the data processing system 10 may be improved, for example, by enhancing task throughput, i.e. the number of tasks completed by unit of time, or by reducing latency and response time per task.

Receiving a task may, for example, refer to receiving a task descriptor for the particular task. A task descriptor may, for example, be a set of information comprising addresses of or pointers to a task identifier, task data and associated input and output buffers. A task may, for example, be defined by an identifier number of the processing unit associated to the task, and a pointer to or address of an associated input buffer, for receiving the data to be processed next, or input buffer list (IBL) and an associated output buffer, for receiving the processed data, or output buffer list (OBL).

Receiving a task may also refer to receiving only a task identifier or pointer to a task descriptor or it may refer to receiving all data related to the particular task. Similarly, assigning a task may also refer to assigning a task identifier or a task descriptor or any other information for enabling the selected processing unit to execute or perform the task. A task register 14 arranged to store a plurality of tasks may be, for example, any register, buffer or other memory device arranged to store, e.g., task data, task identifiers and/or task descriptors. New tasks may be added dynamically to the task register.

The shown data processing system 10 may comprise a flow chain buffer unit 22 arranged to store one or more task parameter tables defining one or more processing flows of one or more of the plurality of tasks and one or more associated flow chains an each of the flow chains may comprise one or more of the plurality of processing units. The task scheduling device 12 may comprise a task register 14 arranged to store the plurality of tasks, each of the plurality of tasks being associated with the one or more processing flow. The task scheduler controller unit 24 may be arranged to assign the one or more of the plurality of tasks according to a corresponding one of the one or more processing flows.

A processing flow of tasks defined in a task parameter table may be, for example, a linked list or other source of information defining dependencies between and required consecutiveness of tasks when processing a set of data. Just to give an example, compressed video data may first be de-compressed, and then upsizing, colour space conversion and display enhancement may be applied to the video data before displaying the decoded video content. A processing flow of tasks may be associated or mapped to one or more associated flow chains. A flow chain buffer unit 22 may, for example, be a shared memory buffer containing a linked list. The task scheduling device may manage execution of one or several processing flows according to the linked list. A flow chain may comprise one or more of the plurality of processing units 16, 18, 20, i.e., a flow chain may comprise information, how to execute a processing flow of tasks using one or more of the processing units of the data processing system 10. A flow chain may be considered comprising a particular processing unit when, for example, the flow chain comprises a pointer or other identifier of the particular processing unit. This may allow a task of a processing flow to be mapped to processing units 16, 18, 20 being adapted to execute the assigned task without a need for full search of dependencies between tasks at the time of task assignment and high access rate to any external memory, reducing latency and improving QoS of the data processing system 10.

The processing units 16, 18, 20 may be connected to the task scheduling device 12 and may receive the tasks to process and generate a task status event which indicates when an execution of the task is finished. The task status event may be signalled to the task scheduling device 12 and may allow the task scheduling device 12 to assign more tasks to the particular processing unit.

The task scheduling device 12 may be arranged to analyse task status conditions for repeating processing of the same task, and may, for example, assign the same task to the same or another processing unit 16, 18, 20. Additionally or alternatively, the task scheduling device 12 may be arranged to analyse task status conditions for processing tasks sharing data buffers with the finished task. The task scheduling device 12 may be arranged to assign another task to the same processing unit.

For example, the received task status event may allow the task scheduling device 12 to proceed with the flow processing of the data processed by the previously finished task, i.e. assign a subsequent task of the processing flow to a suitable subsequent processing unit of the associated flow chain, which may be the same or a different one of the plurality of processing units 16, 18, 20. Processing flows and flow chains may be event-driven. The task scheduling device 12 may select the processing units flow chain for processing a flow of tasks on a fully modular basis, instead of selecting between pre-defined allowed flows.

Task scheduling may be managed by the task scheduling device 12 without interference by, for example, a central processing unit of a computer that may host the described data processing system 10.

The task scheduler controller unit 24 of the task scheduling device 12 may, for example, be a processing device or logic circuit connected to assign tasks, in response to corresponding processing flows and to receiving the task status events associated with one or more previously assigned tasks, to a corresponding one of the processing units 16, 18, 20 being adapted or configured to execute the assigned task.

The data processing system 10 shown in FIG. 1 may, for example, be a video processing system. It may be an advanced video processing system or device and may, for example, provide a wide range of processing capabilities and hardware acceleration engines as processing units 16, 18, 20 for executing the required tasks. Each task may be dedicated to processing of some portion of a video or image frame. The shown data processing system may provide an efficient way for task switching and multiplexing for video applications incurring minimum power and complexity and maximum throughput and QoS for each task. The shown system 10 may allow for processing multiple video algorithms. It may require only a small area, e.g. a small die area for the task scheduling device 12, whereas the shown system may be considered highly scalable, since more hardware acceleration units may allow, for example, execution of more complicated processing flows but may be managed with the same task scheduling device 12.

The task scheduling device 12 may be connected to the task register unit 24 via a data channel and may be arranged to receive tasks. Tasks may be offline tasks, i.e. non-real-time tasks, and the task scheduler controller unit 24 of the task scheduling device 12 may, for example, be arranged to maximize throughput of tasks or minimize latency of task processing or may be adapted to optimize QoS of the data processing system 10 with respect to an aimed trade-off between throughput and latency. The data processing system 10 may also comprise an input 26 connectable to receive task data. The task data may comprise real-time task data and the task scheduling device 12 may be arranged to receive and schedule one or more real-time tasks. For example, a video processing system may be arranged to receive video streams or support live video communication over a communication network. Other real-time environments may, for example, be mobile devices for automatic control, for example, in robotics. Real-time tasks may be characterized by operational deadlines from event to system response. A real-time task may be executed within strict constraints on response time of the data processing system 10. The task scheduling device 12 may allow using the several processing units 16, 18, 20 for executing different offline and real-time task operations on the incoming data in an efficient way with minimum memory bandwidth, overhead and maximized efficiency to meet high output data rates, and to provide a high QoS.

The task scheduler controller unit 24 of the task scheduling device 12 may comprise an input queue and the task scheduling device 12 may comprise an arbitrating unit 28 arranged to receive the task status events and to insert the task status events into the input queue. The arbitrating unit 28 or arbiter may be connected, e.g., via control channels between the processing units 16, 18, 20 and the arbitrating unit 28, to receive at least the task status events generated by the processing units 16, 18, 20. It may or may not also receive other events. The arbitrating unit 28 may insert the tasks status events or the corresponding tasks or other data identifying the corresponding tasks from the task register 14 into the input queue of the task scheduler controller unit 24. The arbitrating unit 28 may also be connectable to input 26 for receiving real-time tasks or other new tasks for inserting into the input queue of the task scheduler controller unit 24. Each task having an entry in the input queue of the task scheduler controller unit 24 may have assigned a priority identifier, which may, for example, be used by the arbitrating unit 28 for inserting the entry in the input queue at a position reflecting its priority of processing. In another embodiment of the data processing system 10, the priority information may be evaluated by the task scheduler controller unit 24 instead of the arbitrating unit 28. The input queue may be comprised in the task scheduler controller unit 24 or it may be implemented as a separate unit connected to the task scheduler controller unit 24.

For pipeline-like assignment of tasks to processing devices, the task scheduling device 12 may be arranged to assign tasks to different of the plurality of processing units 16, 18, 20 for at least partly parallel execution of the tasks. The tasks may, for example, be associated with the one or more processing flows. The one or more processing flows may, for example, be the same processing flows, i.e., tasks constituting the same processing flow may be distributed across the available processing units 16, 18, 20. Additionally or alternatively, the processing flows may, for example, be different processing flows, i.e., tasks associated with different of the processing flows may be assigned to the available processing units 16, 18, 20. In other words, tasks belonging to different processing flows may be executed in parallel on the plurality of processing units.

In case consecutive processing of certain tasks of a processing flow is not mandatory, tasks belonging to the same processing flow may be executed in parallel on available processing units 16, 18, 20, too. One or more of the processing units 16, 18, 20 may, for example, be arranged to execute tasks of single and multiple processing flows in a time-multiplex mode. The processing units 16, 18, 20 may operate in parallel or with time-multiplexing of tasks dedicated to processing different segments of the same processing flow or different processing flows. An at least partly parallel execution of tasks may be an execution of tasks being in parallel for at least a portion of the total processing time of the tasks. Some of the processing units 16, 18, 20 may, for example, at least partly provide the same functionality and may be arranged to provide multi-threading support.

The task scheduling device 12 may comprise a plurality of task output queues 30, 32, 34, each connectable to a corresponding one of the plurality of processing units 16, 18, 20. The task scheduler controller unit 24 may be arranged to assign one or more of the plurality of tasks to the corresponding one of the processing units 16, 18, 20 arranged to execute the assigned task by inserting the one or more of the plurality of tasks into one or more of the task output queues 30, 32, 34. Providing a dedicated task output queue for each of the processing units 16, 18, 20 may help avoid bottlenecks and performance-degrading head of line blocking and may enable high task throughput and response time and, thereby, enhanced QoS, increasing suitability for real-time applications. Providing a task output queue for each processing unit 16, 18, 20 may enable parallel queuing of tasks, multi-threading and parallel computing of the processing units.

The task scheduling device may comprise a plurality of queue control units 36, 38, 40 connected to the plurality of task output queues 30, 32, 34, each of the plurality of queue control units being arranged to assign a task from a connected task output queue 30, 32, 34 to a corresponding processing unit 16, 18, 20 in response to an availability information of the corresponding processing unit. The availability information may be comprised in or derived from the task status events signalled by the particular processing unit, or it may, for example, be comprised in a dedicated event, that may be signalled, e.g., directly to the corresponding queue control unit. A new task may be assigned, for example, one clock cycle after the previous task was finished, enabling full utilisation of the processing unit.

A queue control unit or queue launch machine (QLM) may, for example, be any logic circuitry or processing device implementing a queue state machine arranged to manage the tasks in the corresponding connected task output queue and allocate the next assigned task to the connected processing unit.

In an embodiment of the data processing system 10, at least one of the plurality of queue control units 36, 38, 40 may be arranged to assign a task from a connected task output queue 30, 32, 34 to a corresponding processing unit 16, 18, 20 in response to a priority of the task, i.e., the task scheduler controller unit 24 and the arbitrating unit 28 may be provided with reduced complexity, and, for example, only queue control units 36, 38, 40 managing task allocation of tasks that may use a priority information, may be provided with circuitry for evaluating priority information. Reduced complexity arbitration unit 28 and task scheduling controller 24 may allow for very fast arbitration and task scheduling, respectively. Within each task output queue 30, 32, 34, the queue control unit 36, 38, 40 may select the next task to be run in the connected processing unit 16, 18, 20 with respect to a task priority. The priority associated with the task may be adapted dynamically, for example, in response to an availability of the shared memory buffer, a waiting time in the task output queue or a static priority of the processing flow the task belongs to.

The data processing system 10 may comprise one or more memory buffer units. The one or more memory buffer units may, for example, be configurable to comprise an input buffer and an output buffer for each task assigned to a processing unit 16, 18, 20. The one or more memory buffer units may, for example, be shared memory buffer units, i.e. the data processing system 10 may comprise one or more shared memory buffer units 42, 44, 46, 48.

Shared memory may be memory that may be accessed by multiple processing units 16, 18, 20 executing multiple tasks, for example to provide communication among them or to avoid redundant copies. For example, an output buffer of a first task executed by a first processing unit 16 may be changed into an input buffer of a second task executed by a second processing unit 18 that may receive the processing result of the first processing unit 16 as input for further processing, without copying or moving the data. The internal memory shared buffers between different tasks may reduce the memory load and the need to access external memory devices for intermediate results. The shown data processing system 10 may reduce memory load and power consumption while providing a scalable architecture for adding additional image or video processing accelerators or other processing units.

The data processing system 10 may comprise a switching unit 50 arranged to connect the plurality of processing units 16, 18, 20 to the one or more shared memory buffer units 42, 44, 46, 48. A switching unit 50 may, for example, be a cross-bar switch or any other switching device or multiplexer arranged to connect the processing units 16, 18, 20 to one or more of the shared memory buffer units 42, 44, 46, 48.

Referring to FIG. 2, a diagram of a first example of a flow chain is schematically shown. The shown flow chain may, for example, comprise processing units of a video processing system. It may, for example, comprise a video direct memory access unit 52 (VDMA), a resizing and enhancement filter unit 54 (REF), a wavelet encoding/decoding unit (WCD), and a compressed data direct memory access unit 56 (CDMA). Other processing units, for executing other tasks, such as, for example, other image or video encoding and decoding, motion compensated frame rate conversion or 3D-video processing may be used in flow chains of a video processing system, for example, image direct memory access units (IDMAC) or real-time direct memory access units (RDMA).

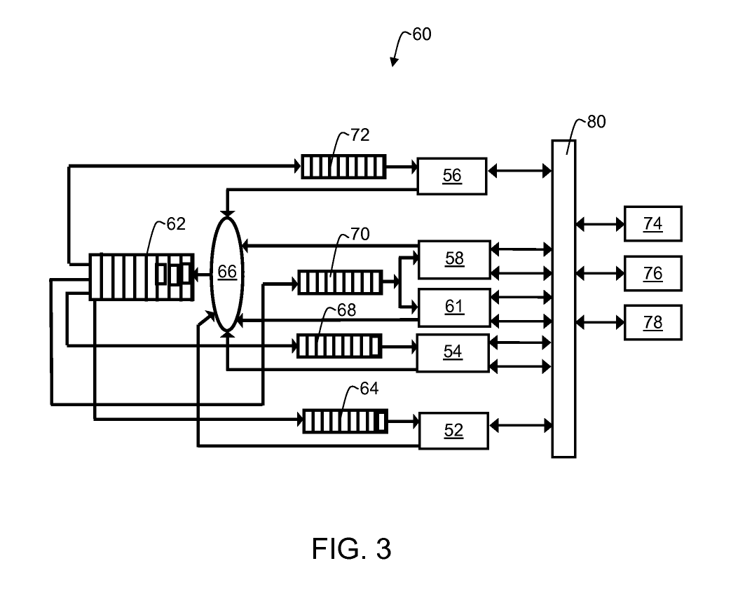

Referring to FIG. 3, a diagram of an example of a second embodiment of a data processing system is schematically shown. Only blocks differing from the data processing system shown in FIG. 1 will be described in detail. The shown data processing system 60 may be arranged to execute processing flows of tasks, for example, using the flow chain shown in FIG. 2. Task scheduling may be enabled by a controller unit, e.g., a reduced instruction set controller unit (not shown). The task iteration may be enabled by the task scheduler controller unit having an input queue 62.

When executing a processing flow, using the flow chain shown in FIG. 2, a first task may be added to task output queue 64 for execution by VDMA processing unit 52. The processing units 52, 54, 56, 58, 61 may be connected to shared memory buffers 74, 76, 80 for read and write access via switching unit 80. On completion of the first task of the associated processing flow, a task status event may be sent to an arbitrating unit 66, which may add a next task of the processing flow to the task scheduler controller input queue 62. The task scheduler controller unit may assign the next task to task output queue 68 for processing by processing unit 54. After completion of the task and generation of the corresponding task status event, the arbitrating unit 66 may iteratively add the next task of the processing flow to the task scheduler controller input queue 62, which may then be added to a task output queue 70. The task may then be allocated to processing unit 58 of the two processing units 58, 61 connected to the task output queue 70. Another task iteration may follow, using task output queue 72 and processing unit 56. Other tasks belonging to other processing flows may be scheduled any time after or in between scheduling of the described tasks.

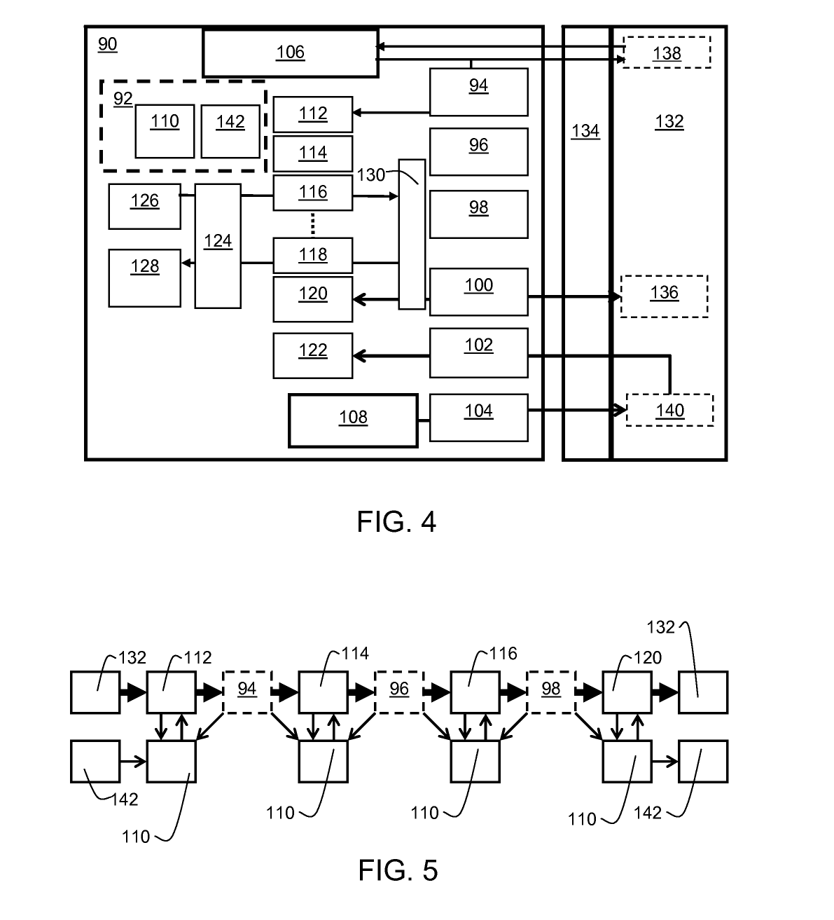

Referring to FIG. 4, a diagram of an example of a third embodiment of a data processing system is schematically shown. Only blocks differing from the data processing system shown in FIG. 1 will be described in detail. The illustrated data processing system 90 may be a video processing system comprising a task scheduling device 92, a plurality of internal memory buffer units 94, 96, 98, 100, 102, 104, which may be shared memory buffer units, a video coding unit 106, which may be arranged to encode or decode received input video data or to provide video coding algorithms to processing units of the task scheduling device 92, and a graphics processing unit 108 (GPU) arranged to provide dedicated graphics processing, e.g., for creating graphics overlay for video frames. The task scheduling device 92 may, for example, comprise a task scheduler controller unit 110 or first controller unit, arranged to assign tasks to a plurality of processing units 112, 114, 116, 118, 120, 122, 124. The processing units may, for example, comprise a VDMA unit 112, a CDMA unit 120, an IDMAC unit 122 and an RDMA unit 124. For receiving input video data, the data processing device 90 may, for example, comprise an input data interface 126, such as a camera sensor interface, connectable to a camera sensor. It may comprise a data output controller and interface 128, such as display controller and interface, connectable to a display unit, such as a monitor or other display screen. The processing units 112, 114, 116, 118, 120, 122, 124 may be connectable to the internal memory buffer units 94, 96, 98, 100, 102, 104 of the data processing system 90 via a switching unit 130, which may be, for example, a cross-bar switch (CBS). The data processing system 90 may be connectable to an external memory device 132 through an external memory interface 134 (EMI). Shared memory units may be connected to the external memory device 132, for example, via one or more of the processing units.

The data processing system 90 may be arranged to apply processing flows of tasks to the input data received through data input interface 126. For example, received input video data may be downsized, if necessary, and compressed. Compressed video frames may, for example, be stored in compressed video frame buffers 136 located in the external memory device 132. For compression and decompression, the video codec 106 may use reference buffers 138 located in the external memory 132. The GPU may, for example, be connected to use a shared memory buffer 104 for providing graphics that may be overlaid with the video content. A graphics frame buffer 140 located in the external memory 132 may be connected to receive graphics content. Compressed video data may be subject to temporal interpolation. A processing flow dedicated to displaying video content may comprise accessing compressed video data from the memory using CDMA processing unit 102 and applying a decoding and upsizing. The video for display may then, for example, be subject to colour space conversion (CSC) and may be combined with graphics overlay, for example provided by the GPU 108 and held in the graphics frame buffer 136. After applying further display enhancement, the content, i.e., decoded video and combined graphics, may be delivered to the display controller and interface 128.

Task scheduling may, for example, be initiated by the task scheduler controller unit 110 or an external processing device, or the task scheduling device 92 may comprise a second controller unit 142 arranged to initiate the one or more processing flows. The second controller unit may also be arranged to terminate processing flows. The second controller unit 142 may, for example, be a reduced instruction set computing (RISC) device providing high performance and high-speed operation, or it may be another processing device or microcontroller device.

Referring to FIG. 5, a diagram of an example of a second flow chain is schematically shown. The flow chain may, for example, be implemented by the data processing system 90 illustrated in FIG. 4. Bold arrows may refer to content data, such as video data, being processed, whereas thin arrows may refer to signals and events received and provided by the task scheduler controller unit 110. A second controller unit 142, which may, for example, be a RISC device, may be arranged to configure task parameters for a certain task and release it to an arbitrating unit (not shown). The arbitrating unit may release a task, which may be considered a primary task, to the task scheduler controller unit 110 (TSC). The task scheduler controller unit 110 may be arranged to check for input and output buffer availability for the current primary task and may mark related tasks associated through common buffers as secondary tasks. When buffers are available, the task scheduler controller unit 110 may be arranged to release the primary task to a task output queue associated with a processing unit capable of processing the task. In case the task is found already in queue it may be marked as in-queue for future classification. The arbitrating unit may release nest tasks to the task scheduler controller unit 110.

The shown flow chain may be event-driven. After receiving an initial command by the second controller unit 142, the TSC 110 may receive an information that data to be processed is available in an external memory 132, and a buffer availability information from an internal memory buffer 94. In case data and processing unit are available, the TSC 110 may assign the task to a processing unit, for example a direct memory access unit, such as VDMA 112, for execution. VDMA 112 may be arranged to signal a task status event to TSC 110 after finishing the task. On reception of the VDMA task status event, the TSC 110 may be arranged to check availability of input and output buffer, wherein buffer 94, which served as an output buffer for VDMA 112, may now be the input buffer holding the data to be processed by the next processing unit 114 in the flow chain. The output buffer for processing unit 114 may, for example, be buffer unit 96. In case input and output buffers 94, 96 are available, the TSC 110 may assign the next process in the process flow being processed to processing unit 114. After receiving a task status event, signalling completion of task processing, from processing unit 114, TSC 110 may again check buffer availability of buffer 96, which may now serve as input buffer for processing device 116, and buffer 98 and may then be arranged to assign the next task of the processing flow to processing unit 116. On reception of a task status event from processing unit signalling that the assigned task has been completed successfully, TSC 110 may again check buffer 98 availability, assign the next task of the processing flow to the next processing unit 120 in the flow chain. In the shown example, processing unit 120 may be a direct memory access unit arranged to provide the processed output data to an external memory 132. On reception of a task status event indicating successful completion of the last task of the processing flow, TSC 110 may provide an indication to the second controller unit 142, which may, for example, be arranged to terminate the processing flow.

With the described approach, processing overhead caused by the procedure of selecting the next task, may be decreased. Copying of processed data between buffers may be reduced or avoided by using shared memory buffers. External memory copies may not be required when processing a flow chain, except for loading the data to be processed at the beginning of the flow chain and for output of the processing result to external memory 132 at the end of the flow chain. The task throughput of the data processing system may be increased. The processing flow executed by the shown flow chain may be one of many, which may be executed at least partly in parallel. The processing flow may be pipelined. The TSC 110 may receive task status events from processing units of different flow chains. A search for the next task to assign may be possible with only little overhead, since only event related tasks may be checked.

A response time of the data processing system may be fast, for example due to fast task arbitration and multi-threading architecture. This may help reduce processing bottlenecks, reduce latency and avoid head of line blocking.

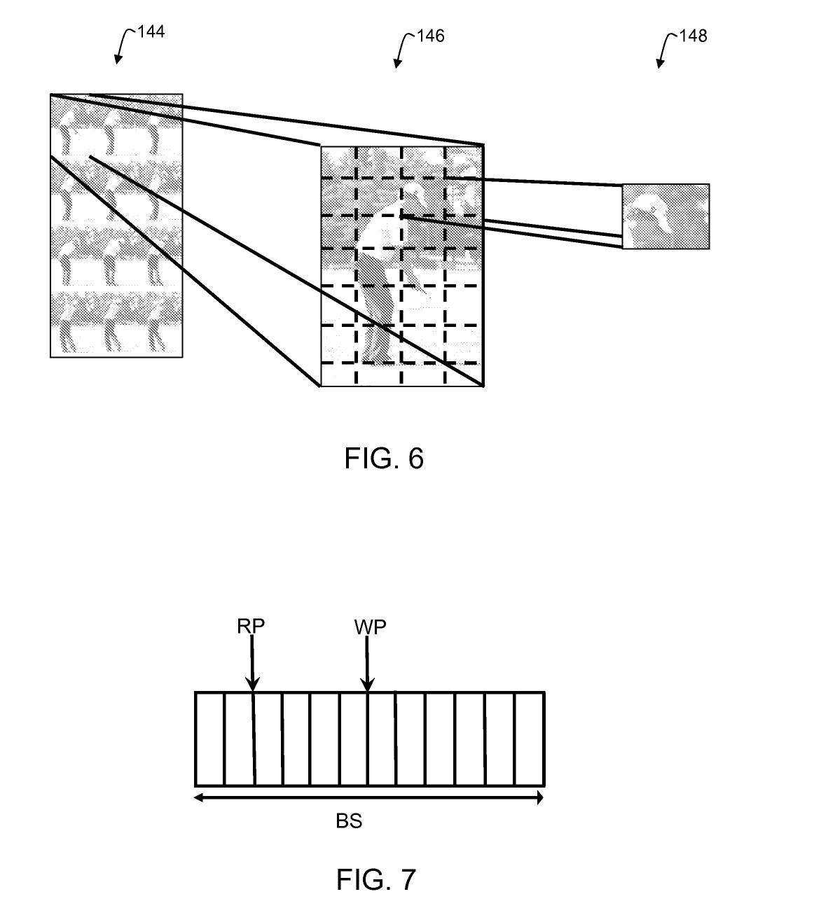

Referring to FIG. 6, a diagram illustrating a control flow hierarchy when processing video data is schematically shown. Just to give an example, a group of image frames 144 of a video sequence is shown. A scheduling of frames, i.e. deciding which frame to assign next to the task scheduling device of a data processing system, may be performed by a second controller unit, such as a microcontroller or RISC processor. Flow parameters may be adjusted on an inter-frame basis. For example, groups of frames or groups of pictures may not be encoded and decoded consecutively when using, for example, encoding or decoding according to an MPEG (moving pictures experts group) standard, such as, for example MPEG-1, MPEG-2 or MPEG-4, and the second controller unit may be arranged to select the next frame to send to the task processing device.

Intra-frame level scheduling performed by a task scheduling device may then be applied, for example, to single video or image frames 146, which may be divided into blocks or pages for further processing. A page may be a portion of the video frame processed by one task run.

Intra-page level scheduling and processing may be applied to pages 148 of a frame and may be performed by dedicated acceleration engines or other processing units of the data processing system.

Referring to FIG. 7, a diagram of an example of a shared buffer unit is schematically shown. In a flow chain, data may be passed between tasks executed by processing units of the flow chain through shared buffers. The shared buffer unit may, for example, be a barrel shifter BS comprising a write pointer WP, for example, set by a task executed on a first processing unit, and a read pointer RP, for example, set by a second processing unit subsequent to the first processing unit in a flow chain. The buffer architecture may, for example, be a single input single output (SISO) buffer architecture. A read threshold R_THR may depend on the amount of data to be read within a single read access. A write threshold W_THR may depend on the amount of data to be written into the buffer within a single write access. If WP−RP>R_THR is found true, the buffer BS may be considered free to read. If BS−(WP−RP)>W_THR is found true, the buffer BS may be considered free to write. Other possible buffer architectures may comprise a single input multiple output (SIMO) buffer architecture, where one write pointer and a plurality of read pointers may be used and different tasks may be allowed to set their read pointer.

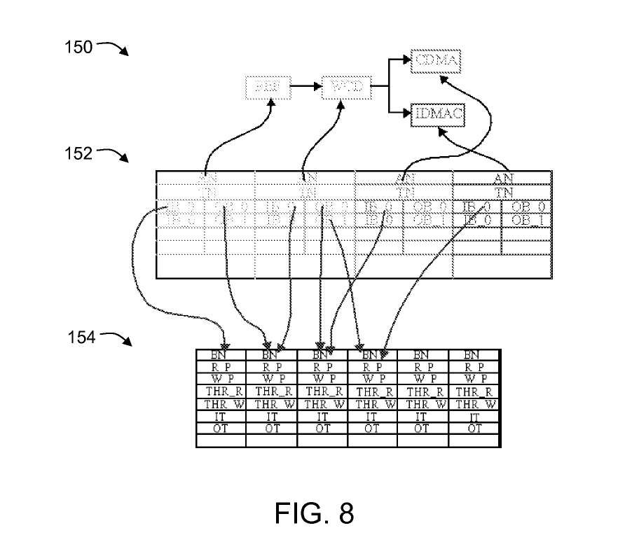

Referring to FIG. 8, a diagram of an example of a third flow chain 150 and associated buffer is schematically shown. In the shown example, the flow chain may be composed by processing units REF, WCD, CDMA and IDMAC connected in a cause-effect chain, where the flow may indicate that the first processing unit is REF, followed by WCD that feeds CDMA and IDMAC to conclude the flow chain. Each processing unit or accelerator unit, identified by its accelerator number AN, in the flow chain may have assigned a task, identified by its task number TN, and each task may have associated input buffer IB and output buffer OB, each having a buffer number BN, associated read and write pointers R_P, W_P, read and write thresholds THR_R and THR_W and input task to buffer IT and output tasks to buffer OT identifiers. The shown arrows may indicate, which of the shown task descriptors 152 may correspond to a task executed by a particular processing unit, and which of the buffer descriptors 154 may identify input and output buffer for an associated task descriptor.

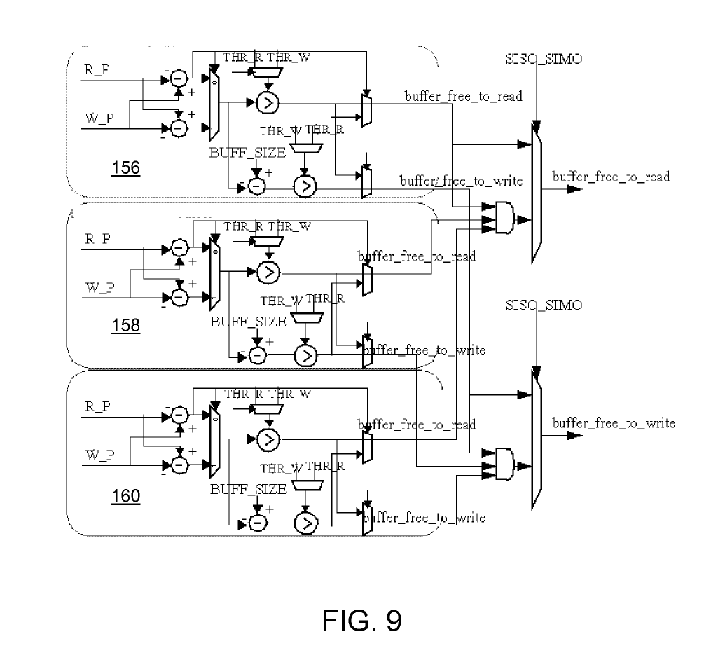

Referring to FIG. 9, a diagram of an example of a buffer classification logic is schematically shown. A buffer classification logic may be a part of a queue control unit or the task scheduler controller unit of a task scheduling device and may be arranged to provide a buffer availability information. It may provide information whether or not a buffer is currently free to read and may be a task input buffer or free to write and may serve as a task output buffer, wherein the information may depend on a type of buffer usage, either SISO with one read pointer R_P or SIMO with three read pointers R_P. The shown buffer classification logic may comprise classification circuitry for a first output buffer 156, for a second output buffer 158 and for a third output buffer 160, wherein each classification circuitry may receive their corresponding read pointer R_P, write pointer W_P, read threshold THR_R, write threshold THR_W and the overall buffers size BUFF_SIZE input parameters and may provide corresponding buffer_freeto_read and buffer_free_to_write information.

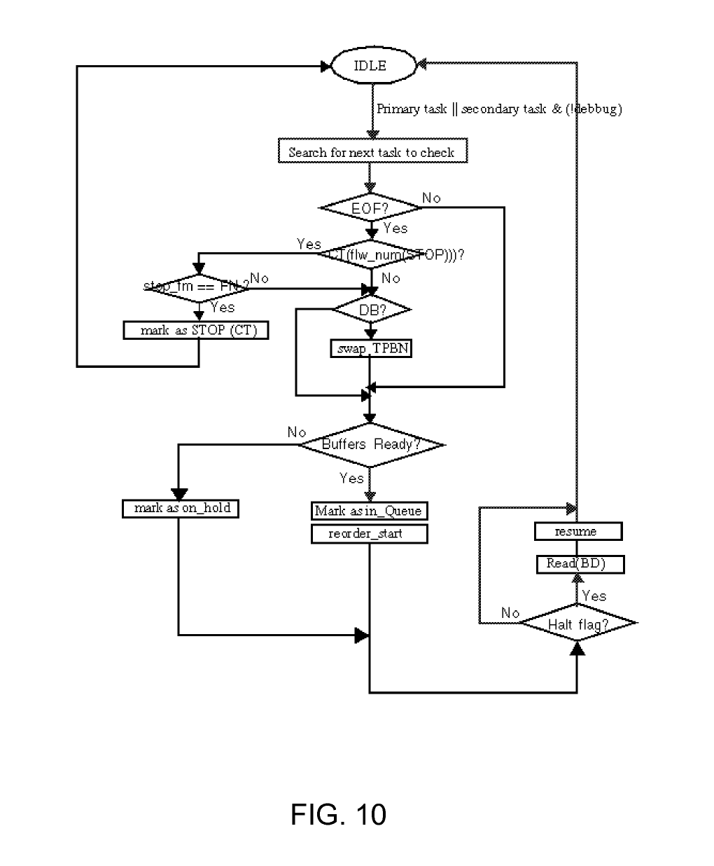

Referring to FIG. 10, a flow diagram of an example of a behaviour of a task scheduler controller unit (TSC) is schematically shown, wherein CT may be the current task being currently scheduled by the TSC, EOF (end of file) may refer to the last task of a processing flow, TPBN may refer to a task parameter buffer number, FLW_NUM may refer to the flow number, DB may refer to a database for task parameters, and BD may refer to a buffer descriptor. The TSC may be activated when there is any primary or secondary task to be checked, i.e. when a task being scheduled is in an ON_CHECK state. In this case, the TSC has not yet made a decision what to do with the task. The TSC may be in IDLE state when the TSC input queue is empty and no task is being checked. When a task is found in the queue, it may be checked whether the buffers associated with the current task are available. If they are available, the task may be added to a task output queue by marking the status of the respective task as IN_QUEUE. After the buffer ready check, the TSC may update other tasks associated to the current task that share common buffers.

Then the TSC may be arranged to check whether there is a task in halt mode. Halt mode means that task execution has been paused by a processing unit due to internal processing reasons. If a task is found to be in halt mode, a read operation of its pointers is carried out by the TSC and updated to the corresponding processing unit or accelerator. Otherwise, the TSC may switch to IDLE mode.

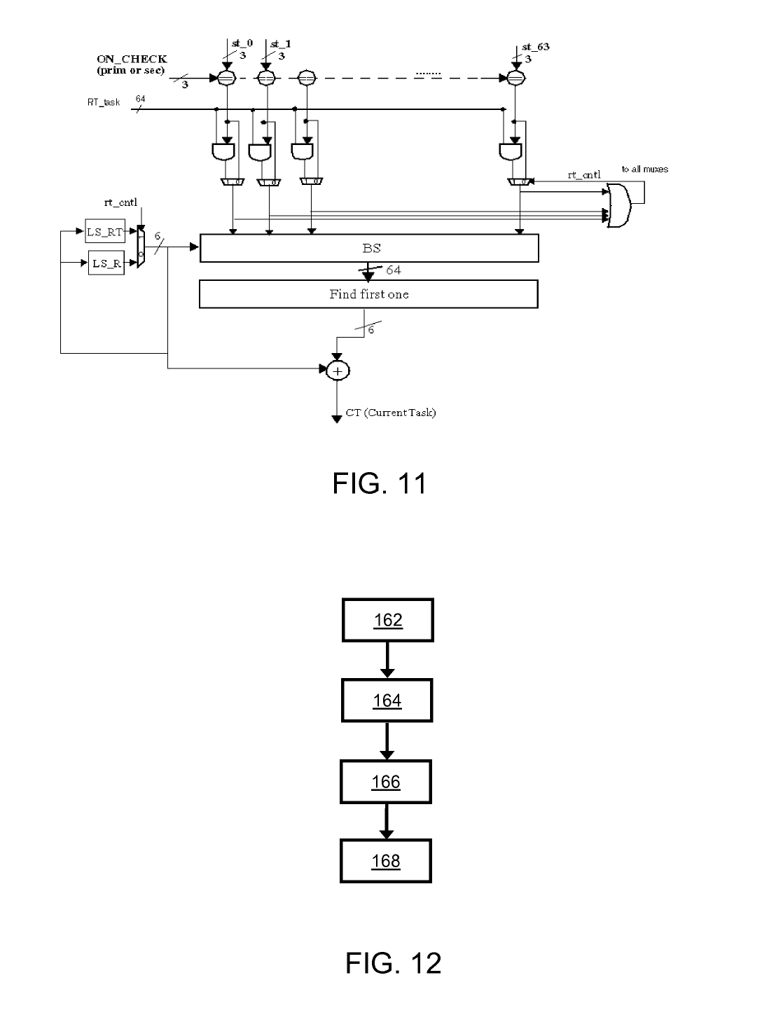

Referring to FIG. 11, an example of a search for next task to check module of a task scheduler controller unit is schematically shown. The shown module may, for example, correspond to the “Search for the next task to check” block shown as part of FIG. 10. The shown module of a TSC may provide an example implementation of a selection logic for selecting the task to be checked in the current run. A logarithmic search may be performed. BS may refer to a barrel shifter buffer memory and RT_task may refer to a bit associated with each task, indicating whether or not the task is a real time task or not. When a real time task is present in the ON_CHECK mode, the TSC may provide maximum QoS. If a task is found to be a real time task, it may be serviced first, before other tasks may receive scheduling service.

Referring to FIG. 12, a diagram of an example of an embodiment of a method for task scheduling in a data processing system is schematically shown. The method shown in FIG. 12 allows implementing the advantages and characteristics of the described data processing system as part of a method for task scheduling in a data processing system. The method is a method for task scheduling in a data processing system comprising a task scheduling device having a task scheduling controller unit; and a plurality of processing units, at least some of which being adapted to execute one or more assigned tasks of a plurality of tasks. The method comprises providing 162 the plurality of tasks to the task scheduling device; assigning 164 tasks of the plurality of tasks to the plurality of processing units; for each assigned task, providing 166 to the task scheduling device at least a task status event which indicates when an execution of the assigned task is finished; and assigning 168, by the task scheduler controller unit, one or more of the plurality of tasks, to a corresponding one of the processing units being adapted to execute the assigned task, in response to receiving one or more of the task status events associated with one or more previously assigned tasks.

The method may comprise storing, in a flow chain buffer unit, one or more task parameter tables defining one or more processing flows and one or more associated flow chains, each of the flow chains comprising one or more of the plurality of processing units. The method may further comprise storing, in a task register, the plurality of tasks, each of the plurality of tasks being associated with one or more of the processing flows of one or more of the plurality of tasks.

A programmable apparatus may be provided for at least partly executing the steps of the shown method. A computer program product may comprise code portions for executing steps of a method as described above when run on a programmable apparatus.

The invention may also be implemented in a computer program for running on a computer system, at least including code portions for performing steps of a method according to the invention when run on a programmable apparatus, such as a computer system or enabling a programmable apparatus to perform functions of a device or system according to the invention.

A computer program is a list of instructions such as a particular application program and/or an operating system. The computer program may for instance include one or more of: a subroutine, a function, a procedure, an object method, an object implementation, an executable application, an applet, a servlet, a source code, an object code, a shared library/dynamic load library and/or other sequence of instructions designed for execution on a computer system.

The computer program may be stored internally on computer readable storage medium or transmitted to the computer system via a computer readable transmission medium. All or some of the computer program may be provided on transitory or non-transitory computer readable media permanently, removably or remotely coupled to an information processing system. The computer readable media may include, for example and without limitation, any number of the following:

magnetic storage media including disk and tape storage media; optical storage media such as compact disk media (e.g., CD-ROM, CD-R, etc.) and digital video disk storage media; nonvolatile memory storage media including semiconductor-based memory units such as FLASH memory, EEPROM, EPROM, ROM; ferromagnetic digital memories; MRAM; volatile storage media including registers, buffers or caches, main memory, RAM, etc.; and data transmission media including computer networks, point-to-point telecommunication equipment, and carrier wave transmission media, just to name a few.

A computer process typically includes an executing (running) program or portion of a program, current program values and state information, and the resources used by the operating system to manage the execution of the process. An operating system (OS) is the software that manages the sharing of the resources of a computer and provides programmers with an interface used to access those resources. An operating system processes system data and user input, and responds by allocating and managing tasks and internal system resources as a service to users and programs of the system.

The computer system may for instance include at least one processing unit, associated memory and a number of input/output (I/O) devices. When executing the computer program, the computer system processes information according to the computer program and produces resultant output information via I/O devices.

In the foregoing specification, the invention has been described with reference to specific examples of embodiments of the invention. It will, however, be evident that various modifications and changes may be made therein without departing from the broader spirit and scope of the invention as set forth in the appended claims.

The connections as discussed herein may be any type of connection suitable to transfer signals from or to the respective nodes, units or devices, for example via intermediate devices. Accordingly, unless implied or stated otherwise, the connections may for example be direct connections or indirect connections. The connections may be illustrated or described in reference to being a single connection, a plurality of connections, unidirectional connections, or bidirectional connections. However, different embodiments may vary the implementation of the connections. For example, separate unidirectional connections may be used rather than bidirectional connections and vice versa. Also, plurality of connections may be replaced with a single connection that transfers multiple signals serially or in a time multiplexed manner. Likewise, single connections carrying multiple signals may be separated out into various different connections carrying subsets of these signals. Therefore, many options exist for transferring signals.

Each signal described herein may be designed as positive or negative logic. In the case of a negative logic signal, the signal is active low where the logically true state corresponds to a logic level zero. In the case of a positive logic signal, the signal is active high where the logically true state corresponds to a logic level one. Note that any of the signals described herein can be designed as either negative or positive logic signals. Therefore, in alternate embodiments, those signals described as positive logic signals may be implemented as negative logic signals, and those signals described as negative logic signals may be implemented as positive logic signals.

Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures can be implemented which achieve the same functionality. For example, the task scheduler controller unit 24, the arbitrating unit 28 and the task output queue controller units 36, 38, 40 may be provided as different circuits or devices or integrated in a single device. Or the flow chain buffer module 22 may be provided connected to or integrated in the task scheduling device 12.

Any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

Also for example, in one embodiment, the illustrated examples may be implemented as circuitry located on a single integrated circuit or within a same device. For example, the data processing system 10 may be provided as a system on a chip in a single integrated circuit. Alternatively, the examples may be implemented as any number of separate integrated circuits or separate devices interconnected with each other in a suitable manner. For example, the task scheduling device 12 and the processing units 16, 18, 20 may be provided as separate integrated circuits.

Also for example, the examples, or portions thereof, may implemented as soft or code representations of physical circuitry or of logical representations convertible into physical circuitry, such as in a hardware description language of any appropriate type.

Also, the invention is not limited to physical devices or units implemented in non-programmable hardware but can also be applied in programmable devices or units able to perform the desired device functions by operating in accordance with suitable program code, such as mainframes, minicomputers, servers, workstations, personal computers, notepads, personal digital assistants, electronic games, automotive and other embedded systems, cell phones and various other wireless devices, commonly denoted in this application as ‘computer systems’.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements The mere fact that certain measures are recited in mutually different claims does not indicate that a combination of these measures cannot be used to advantage.

While the principles of the invention have been described above in connection with specific apparatus, it is to be clearly understood that this description is made only of way of example and not as a limitation on the scope of the invention.

1. A data processing system, comprising:
a task scheduling device arranged to schedule a plurality of tasks; and
a plurality of processing units, wherein
one or more of the plurality of processing units is adapted to
execute one or more assigned tasks of said plurality of tasks, and
for each assigned task, to provide to said task scheduling device at least a task status event which indicates when an execution of said assigned task is finished, and
said task scheduling device comprises a task scheduler controller unit arranged to assign one or more of said plurality of tasks, each to a corresponding one of said processing units being adapted to execute said assigned task, in response to receiving one or more of said task status events associated with one or more previously assigned tasks.

2. The data processing system as claimed in claim 1, comprising:
a flow chain buffer unit arranged to store one or more task parameter tables defining one or more processing flows of one or more of said plurality of tasks and one or more associated flow chains; and
each of said flow chains comprising one or more of said plurality of processing units, wherein
said task scheduling device comprises a task register arranged to store said plurality of tasks, each of said plurality of tasks being associated with said one or more processing flows, and
said task scheduler controller unit is arranged to assign said one or more of said plurality of tasks according to a corresponding one of said one or more processing flows.

3. The data processing system as claimed in claim 1, wherein said data processing system is a video processing system.

4. The data processing system as claimed in claim 1, wherein said task scheduling device is arranged to receive and schedule one or more real-time tasks.

5. The data processing system as claimed in claim 1, wherein
said task scheduler controller unit comprises an input queue; and
said task scheduling device comprises an arbitrating unit arranged to receive said task status events and to insert said task status events into said input queue.

6. The data processing system as claimed in claim 1, wherein said task scheduling device is arranged to assign tasks to different of said plurality of processing units for at least partly parallel execution of said tasks.

7. The data processing system as claimed in claim 1, wherein said task scheduling device comprises a plurality of task output queues, each connectable to a corresponding one of said plurality of processing units, and wherein said task scheduler controller unit is arranged to assign one or more of said plurality of tasks to said corresponding one of said processing units being adapted to execute said assigned task by inserting said one or more of said plurality of tasks into one or more of said task output queues.

8. The data processing system as claimed in claim 7, wherein said task scheduling device comprises a plurality of queue control units connected to said plurality of output queues, wherein each of said plurality of queue control units is arranged to assign a task from a connected task output queue to a corresponding processing unit in response to an availability information of said corresponding processing unit.

9. The data processing system as claimed in claim 8, wherein at least one of said plurality of queue control units is arranged to assign a task from a connected task output queue to a corresponding processing unit in response to a priority of said task.

10. The data processing system as claimed in claim 1, comprising one or more shared memory buffer units.

11. The data processing system as claimed in claim 10, comprising a switching unit arranged to connect said plurality of processing units to said one or more shared memory buffer units.

12. The data processing system as claimed in claim 1, wherein said task scheduling device comprises a second controller unit arranged to initiate said one or more processing flows.

13. A method for task scheduling in a data processing system comprising a task scheduling device having a task scheduling controller unit and a plurality of processing units adapted to execute one or more assigned tasks of a plurality of tasks, said method comprising:
providing said plurality of tasks to said task scheduling device;
assigning tasks of said plurality of tasks to said plurality of processing units;
for each assigned task, providing to said task scheduling device at least a task status event which indicates when an execution of said assigned task is finished; and
assigning, by said task scheduler controller unit, one or more of said plurality of tasks to a corresponding one of said processing units being adapted to execute said assigned task, in response to receiving one or more of said task status events associated with one or more previously assigned tasks.

14. (canceled)
